(19) United States
(12) Patent Application Publication
(10) Pub. No.: US 2015/0137653 A1
(43) Pub. Date: May 21, 2015

(54) ELECTRIC MACHINE WITH HOUSING SEGMENTS AND STATOR SEGMENTS

(71) Applicant: Siemens Aktiengesellschaft, 80333 München (DE)

(72) Inventors: Peter Petereit, Berlin (DE); Christian Schiller, Berlin (DE); Rüdiger Schäfer, Berlin (DE)

(73) Assignee: SIEMENS AG, München (DE)

(21) Appl. No.: 14/365,379

(22) PCT Filed: Nov. 14, 2012
(86) PCT No.: PCT/EP2012/072585

§ 371 Date: Jun. 13, 2014

(30) Foreign Application Priority Data
Dec. 15, 2011 (DE) 10 2011 088 660.5

(51) Int. Cl. H02K 1/18; H02K 15/00

(52) U.S. Cl. CPC H02K 1/185; H02K 15/00; H02K 2201/03; H02K 2201/15
USPC 310/216.113; 29/596

(57) ABSTRACT

In summary, the invention relates to an electric machine having a housing, a stator which is arranged in the housing and a rotatable rotor arranged inside the stator, wherein the housing comprises at least two housing segments, and the stator comprises at least two stator segments, and a method for manufacturing such a machine. In order to provide an electric machine which has favourable transportation and installation properties together with a high output power and permits a precisely adjustable air gap to be made available despite customary fabrication tolerances of its components, it is proposed that it be possible to secure each of the stator segments individually to one of the housing segments by means of, in each case, at least one mechanically detachable connection.

The invention relates to an electric machine having a housing, a stator disposed in the housing, and a rotatable rotor disposed inside the stator, wherein the housing comprises at least two housing segments and the stator at least two stator segments, and to a method for producing such a machine.

An electric machine and/or method of this kind are to be found, for example, in tube mills. The motors required for the operation thereof can be particularly powerful and have diameters of several meters. For transportation reasons, such motors often consist of a plurality of smaller segments which are then assembled on-site and, in the assembled state, simultaneously constitute the housing and the stator.

DE 10 2007 005 131 B3 discloses a tube mill ring motor which comprises, among other things, a plurality of stator segments and housing covers as well as a rotor, said ring motor having an air gap between the stator and the rotor. The stator segments each have a winding system and simultaneously constitute the support structure of the ring motor.

The object of the invention is to create an electric machine of high output power which has favorable transportation and installation features and allows a precisely adjustable air gap to be achieved despite normal manufacturing tolerances of the components thereof.

This object is achieved for an electric machine of the type mentioned in the introduction by making each of the stator segments individually fixable to one of the housing segments by means of at least one mechanically releasable connection.

This object is also achieved by a mill as claimed in claim 6. As mill drives pose particular requirements in respect of output, torque and stability of the supporting structure, it is particularly advantageous for an electric machine to be used there.

Lastly, this object is also achieved by a method for producing an electric machine as claimed in claim 7.

According to the invention, the stator and the housing are two separate machine components which are each subdivided into segments. This allows particularly large and powerful electric machines to be constructed by assembling the respective segments. Such high-powered machines are used, for example, in mill drives, in particular as a direct drive system.

An important aspect of the present invention is the separation of the stator from the housing such that the electric machine has housing segments and separate stator segments. As powerful machines in particular cannot be transported in one piece, i.e. in the assembled state, as they are too large and heavy to be transported, e.g. by means of a crane system, over bridges or through tunnels, the subdivision into a separate housing, consisting of at least two housing segments, and a separate stator, consisting of at least two stator segments, offers particular advantages for transportation.

The mechanically releasable connection is used, among other things, to transmit the counter-torque of the motor from the stator to the supporting structure of the housing and can be implemented in particular in a form- or force-fit manner. The connection, e.g. in the form of a screw connection, makes the machine relatively easy to assemble. For example, stator segments can be used in such a way that they are comparatively small and produced in larger quantities. In addition, the connection can be used for adjusting the stator segments. This is particularly advantageous if housing segments and stator segments having comparatively loose manufacturing tolerances are used and the mechanically releasable connection can be used to compensate the tolerances. This is also an advantageous aspect for housing deformation due to gravity, particularly in the case of large and heavy machines, as re-adjustments can also be made. Moreover, the larger quantities of stator segments and the generous manufacturing tolerances enable production costs to be reduced.

It is also particularly advantageous that, in the case of an electric machine according to the invention, individual defective or damaged stator segments can be replaced without major outlay. For this purpose it is merely necessary to release the connection between the stator segment in question and the housing segment supporting it, remove the defective or damaged stator segment and finally fix a suitable stator segment to the housing segment again by means of at least one mechanically releasable connection. This enables the maintenance and repair work required to be carried out quickly and cost-effectively.

In addition, the respective stator segments can be designed such that they each comprise electric windings or coils and impregnation of the windings or coils does not take place until they are mounted on the respective stator segments. The impregnation can be carried out, for example, as vacuum pressure impregnation. This initially allows the not yet impregnated windings to be mounted on the respective stator segment, wherein it is quite possible for a plurality of windings to be mounted. The windings can be implemented, for example, as coil, lap, bar or toothed windings.

In an advantageous embodiment of the invention, at least two of the stator segments can be fixed to one of the housing segments.

Fixing at least two stator segments to a housing segment enables the housing to be comparatively coarsely structured, so that the housing is subdivided into only a small number of housing segments. As a result, the number of joints between the housing segments is reduced. As counter-torques with respect to drive torques of the electric machine stress the housing, the reduction in the number of joints contributes significantly to the stability of the machine.

At the same time, the stator can be relatively finely subdivided. The already mentioned adjustment of the stator segments in the housing segments can be carried out more precisely, as the stator can be subdivided into finer stator segments. Another advantage of the finer subdivision of the stator is that such stator segments can be manufactured in standardized form and, thanks to the larger quantities and lower development or matching requirements, the manufacturing costs can be reduced.

In another advantageous embodiment of the invention, any air gap between the respective stator segments and the rotor can be adjusted by means of the respective connection such that the air gap for each of the stator segments is the same as a predefinable air gap.

The mechanically releasable connection between the respective stator segments and the respective housing segments enables the air gap to be adjusted separately for each individual stator segment. Particularly for large machines in which, because of their dead weight, deformations may occur, precise adjustment of the air gap and likewise of the stator's internal diameter can therefore take place during assembly on-site. Any deformations can thus be compensated. At the same time, more generous manufacturing tolerances can be selected for the housing segments and the stator segments, which reduces the manufacturing costs of the housing segments and stator segments.

In another advantageous embodiment of the invention, the stator segments each comprise at least two windings which are each part of an overall stator winding.

Mounting at least two windings on each stator segment simplifies the manufacture of the stator as a whole. Often during the production of stators or stator segments, a coil is first wound, drawn and insulated, e.g. by taping. The coil is then impregnated and finally the insulated and impregnated coil is inserted into the stator.

The simplification is now that the respective stator segment is first provided with at least two windings, e.g. with 20 windings, which can already have an insulating taping. As a result, the impregnation of at least two or more windings can take place in a single operation by impregnating the entire stator segment including mounted windings, which simplifies manufacture and makes it less expensive.

For this purpose the stator segment including windings advantageously has a spatial extent such that it can be impregnated in a single process, in particular by placing it in a vessel for performing vacuum pressure impregnation. The impregnation of stator segments including not yet impregnated windings allows altogether faster impregnation of the windings, particularly compared to the impregnation of individual windings for the production of larger motors.

The advantage becomes particularly apparent if an electric machine is particularly large and powerful. For example, such machines can have some 600 windings which hitherto have been impregnated individually and only assembled into a stator thereafter. It is now possible to distribute the 600 windings over 12 stator segments so that each stator segment is provided with 50 windings which are impregnated together in a single operation in each case.

In another advantageous embodiment of the invention, the electric machine has an output of more than 10 MW. Such powerful machines can be used in particular for large ring motors and for mill drives. For example, the drive power can range from 20 to 40 MW.

Impregnation by means of vacuum pressure also enables large voltage steps, e.g. in excess of 6 kV, to be implemented between individual windings and individual stator segments. This is particularly advantageous in the case of high-pole and low-speed machines of the type used, for example, in generators and compressor drives as well as in the mining and ore processing industries.

Apart from that, the present invention can be carried over from rotary electric machines to linear electric machines, e.g. to linear synchronous motors.

The invention will now be described and explained in greater detail with reference to the exemplary embodiments illustrated in the accompanying drawings in which:

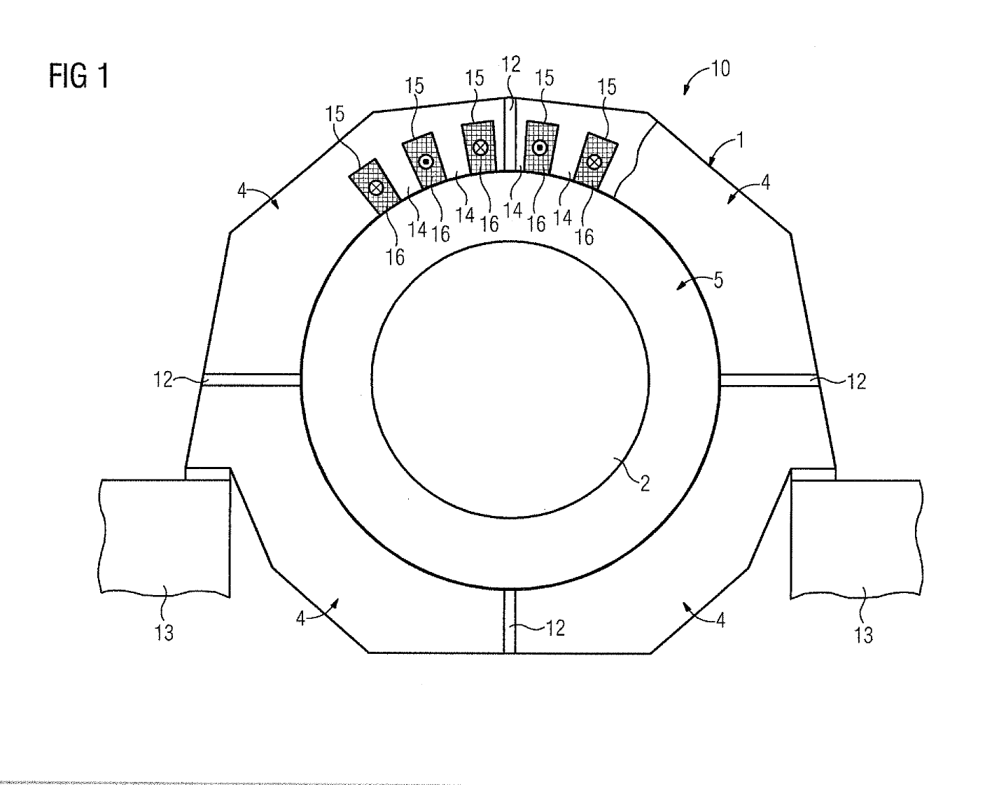

FIG. 1 shows an electric machine according to the prior art, and

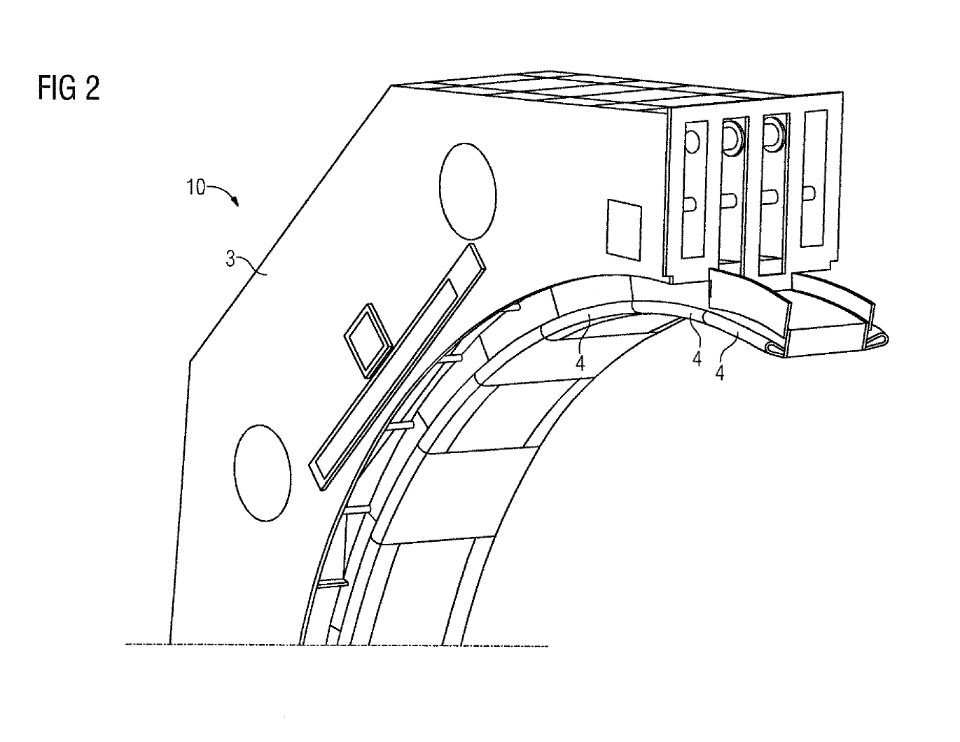

FIG. 2 shows part of a schematic representation of an embodiment of an electric machine according to the invention.

FIG. 1 shows an electric machine according to the prior art. A ring motor 10 has a stator 1 having stator segments 4 and a rotor 2, wherein an air gap 5 is disposed between the stator 1 and the rotor 2. The stator segments 4 are interconnected via separators 12, wherein the ring motor 10 rests on a base 13 via two bearing surfaces. The stator segments 4 have a winding system comprising teeth 14, slots 15 and tooth-wound coils 16.

FIG. 2 shows part of a schematic representation of an embodiment of an electric machine 10 according to the invention. A plurality of stator segments 4 are each fixed to a housing segment 3 by means of a mechanically releasable connection. A cylindrical housing is formed by a plurality of housing segments 3, and a cylindrical stator 1 by a plurality of stator segments 4, wherein a desired stator internal diameter can be adjusted by means of the connection. An air gap 5 between the stator 1 and a cylindrical rotor 2 is therefore adjustable, wherein the adjustable distance between the rotor 2 and the respective stator segment 4 can be selected by means of the mechanically releasable connection, e.g. in the form of a screwed connection, and is normally selected and adjusted identically for each stator segment 4.

The housing segments 3 are comparatively large and robust components, as they have to pass on the required counter-torque of the electric machine 10, said counter-torque being supplied to them via the connection of the stator segments 4. Also for stability reasons the housing is composed of a comparatively small number of housing segments 3 which are selected relatively large, as connection points between housing segments 3 weaken the supporting structure.

In contrast, the stator segments 4 can, on the one hand, be selected small compared to the housing segments 3, so that a plurality of stator segments 4 can each be fixed to a housing segment 3. On the other hand, as a plurality of windings can be mounted on the respective stator segments 4, the stator segments 4 can be made large compared to the windings. For example, several dozen windings or coils can be mounted on a stator segment 4. The size of the respective stator segments 4 including the respective mounted windings is preferably designed such that the entire stator segment 4 including mounted windings can be impregnated in a single operation by means of vacuum pressure impregnation, for which purpose it must be insertable into vessels commonly used for this process.

For reference characters listed here but not shown, see FIG. 1.

To summarize, the invention relates to an electric machine having a housing, a stator disposed in the housing, and a rotatable rotor disposed inside the stator, said housing comprising at least two housing segments and the stator at least two stator segments, and to a method for producing such a machine.

In order to create an electric machine having favorable transportation and installation properties while providing high output power and allowing a precisely adjustable air gap to be achieved despite usual manufacturing tolerances of its components, it is proposed that each of the stator segments be individually fixable to one of the housing segments by means of at least one mechanically releasable connection in each case.

What is claimed is:

1.-9. (canceled)

10. An electric machine, comprising:
a housing having at least two housing segments;
a stator disposed in the housing and having a plurality of stator segments;
a rotatable rotor disposed inside the stator; and
a mechanically releasable connection configured to individually fix the stator segments to the housing segments.

11. The electric machine of claim 10, wherein at least two of the plurality of stator segments are fixed to one of the housing segments.

12. The electric machine of claim 10, wherein the connection is configured to allow adjustment of an air gap between the stator segments and the rotor to correspond to a predefinable air gap for each of the stator segments.

13. The electric machine of claim 10, wherein each of the stator segments comprises at least two windings which are part of an overall stator winding.

14. The electric machine of claim 10, constructed to have an output of more than 10 MW.

15. A mill, comprising an electric machine which includes a housing having at least two housing segments, a stator disposed in the housing and having a plurality of stator segments, a rotatable rotor disposed inside the stator, and a mechanically releasable connection configured to individually fix the stator segments to the housing segments.

16. The mill of claim 15, wherein at least two of the plurality of stator segments are fixed to one of the housing segments.

17. The mill of claim 15, wherein the connection is configured to allow adjustment of an air gap between the stator segments and the rotor to correspond to a predefinable air gap for each of the stator segments.

18. The mill of claim 15, wherein each of the stator segments comprises at least two windings which are part of an overall stator winding.

19. The mill of claim 15, wherein the electric machine has an output of more than 15 MW.

20. A method for producing an electric machine, comprising:
forming a housing from at least two housing segments;
mounting a plurality of stator segments to the housing segments by a mechanically releasable connection to form a stator inside the housing; and
disposing a rotatable rotor inside the stator.

21. The method of claim 20, further comprising configuring the connection to allow adjustment of an air gap between the stator segments and the rotor to correspond to a predefinable air gap for each of the stator segments.

22. The method of claim 20, further comprising providing each of the stator segments with at least two windings which are each part of an overall stator winding, and impregnating each stator segment by vacuum pressure impregnation.
